(19) United States
(12) Patent Application Publication
(10) Pub. No.: US 2007/0177165 A1
(43) Pub. Date: Aug. 2, 2007

(54) Printing tool

(75) Inventor: Amanda Qing Xie, QingDao (CN)

Correspondence Address: MCCORMICK, PAULDING & HUBER LLP, 185 ASYLUM STREET, CITY PLACE II, HARTFORD, CT, 06103, US

(73) Assignee: Lucent Technologies Inc., Murray Hill, NJ (US)

(21) Appl. No.: 11/502,291

(22) Filed: Aug. 10, 2006

(30) Foreign Application Priority Data
Jan. 28, 2006 (CN) 200610084032.X

(51) Int. Cl. G06F 3/12; G06F 17/00

(52) U.S. Cl. 358/1.1; 715/501.1

(57) ABSTRACT

A printing tool has a module allowing printing of at least one linked content item. A request sub-module generates a request to print at least one linked content item, and a retrieval sub-module allows at least one linked content item to be retrieved for printing.

This application is entitled to the benefit of and claims foreign priority under 35 U.S.C. §119 from Chinese Patent Application No. 200610084032.X, filed Jan. 28, 2006, the disclosure of which is hereby incorporated by reference.

### FIELD OF THE INVENTION

The present invention relates to electronic content, such as files, documents, or web pages, that include links to other electronic content and, more particularly, to electronic applications allowing such content to be viewed.

### BACKGROUND OF THE INVENTION

Many types of electronic applications allow a user to view an electronic content item, such an as an electronic file, document, or web page, that contains links to other electronically-viewable content items. These linked content items are, generally, either stored on the user's own computer, or other electronic device, or accessible to the user via a network, such as a local area network (LAN) or the Internet. If desired, the user views a particular linked content item by selecting, or “clicking,” the associated link. The linked content item is then displayed for the user, either by the electronic application in use, and/or by electronic applications launched in response to the user's selection of the link, typically depending upon the location and/or format of the linked content item.

An exemplary type of electronic application with this capability is Internet browsing software. However, many other types of electronic applications, not expressly designed for browsing or navigating links, include a similar capability. For example, most word processing software, spreadsheet software, document viewing software, and electronic presentation software allow documents including links to be generated and viewed.

Many users prefer, or are required, to print a copy of electronic content items for viewing and/or storage. For the content item currently being viewed, this is typically accomplished by selecting a “Print” option in the electronic application in use. However, selecting the “Print” option, is only effective for causing the currently viewed content item to be printed or included in some other printing operation, such as a print preview, print to file, or save as PDF option. Selecting the “Print” option does not effect inclusion of any of the linked content items in the printing operation. Printing any of the linked content items requires the user to individually select each of the links, wait for the linked content item to be located and displayed, and separately select a “Print” option in the electronic application used to display the linked content item. Such a process is potentially both time-consuming and tedious.

The time and effort required to print linked content items increases if a given linked content item includes links to further linked content items the user desires to print. The multiple-step process described above must be again repeated for the user to print such further linked content. In the event the user had not previously printed the original content item, or previously view content items, the user must also somehow return, or navigate, back to the content items to be printed and separately select the “Print” option as appropriate.

“Dump” software is available that allows an Internet browser user to automatically download and save linked content to the user's computer without individually selecting or viewing the applicable links. However, such “dump” software only saves the content for off-line viewing. If the user desires to print any of the off-line linked content, the user must still separately access, view, and print each item of the off-line linked content.

It can be seen that there is a need for a system and/or method that allows for printing of linked content without separately viewing the linked content.

### SUMMARY OF THE INVENTION

According to an embodiment of the present invention, a printing tool has a module allowing printing of at least one linked content item.

According to another aspect of the present invention, a printing tool has a request sub-module for generating a request to print at least one linked content item.

According to an additional aspect of the present invention, a printing tool has a retrieval sub-module allowing at least one linked content item to be retrieved for printing.

### BRIEF DESCRIPTION OF THE DRAWINGS

FIG. 1 is a schematic of an organizational overview of a printing tool, according to an embodiment of the present invention;

FIG. 2 is a diagram of an electronic environment used to describe the functions and operation of the printing tool of FIG. 1;

FIG. 3 is a view of a screen displayed by an application including the printing tool of FIG. 1;

FIG. 4 is a view of a print window with a print request form used to generate a print request by a request sub-module of the printing tool of FIG. 1;

FIG. 5 is a view of the print window of FIG. 4 with additional print request options for the print request form;

FIG. 6 is a view of the print window of FIG. 4 with a configuration option form used to generate configuration data by an administration sub-module of the printing tool of FIG. 1;

FIG. 7 is a flowchart of a compilation routine executed by a retrieval sub-module of the printing tool of FIG. 1;

FIG. 8 is a flowchart of a retrieval routine executed by the retrieval sub-module of the printing tool of FIG. 1;

FIG. 9 is a flowchart of an output routine executed by the retrieval sub-module of the printing tool of FIG. 1;

FIG. 10 is a view of a first notification displayed by the retrieval sub-module during execution of the retrieval routine of FIG. 8;

FIG. 11 is a view of a second notification displayed by retrieval sub-module during execution of the retrieval routine of FIG. 8; and

FIG. 12 is a view of a linked content summary displayed according to another aspect of the printing tool of FIG. 1.

### DETAILED DESCRIPTION

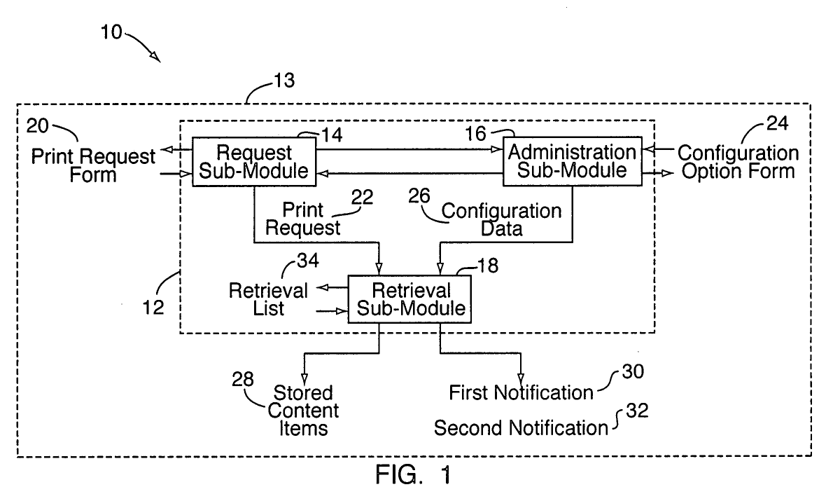

Referring to FIG. 1, the printing tool 10 will be described as a plug-in module 12 for an existing electronic application 13. The plug-in module 12 includes a request sub-module 14, an administration sub-module 16, and a retrieval sub-module 18. The request sub-module 14 generates a print request form 20 for completion by a user of the application 13. The completed print request form 20 is used to generate a print request 22, which is communicated by the request sub-module 14 to the retrieval sub-module 18. The request sub-module 14 also enables access to the administration sub-module 16. The administration sub-module 16 generates a configuration option form 24 for completion by the user of the application 13. Based on the configuration option form 24, configuration data 26 is stored by the administration sub-module 16 to be available to the retrieval sub-module 18. Based on the print request 22 and the configuration data 26, the retrieval sub-module 18 outputs stored linked content items 28, for future printing, first notifications 30, second notifications 32, and a retrieval list 34.

Linked content, as used herein, refers to electronic content obtainable by selecting or following one or more links from the electronic documents or files currently being viewed by the user. Linked content also refers to electronic content from which the currently viewed electronic content was reached by following one or more links.

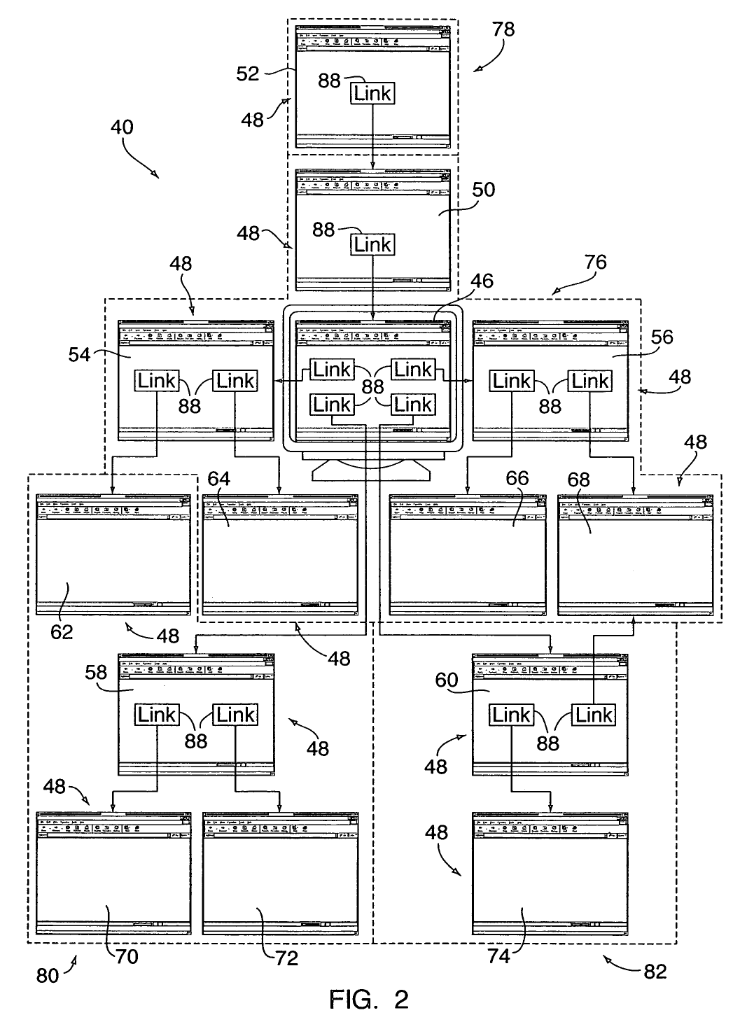

Referring to FIG. 2, in a sample electronic environment 40 in which the printing tool 10 of FIG. 1 may operate, currently-viewed web page 46 includes the currently-viewed electronic content. Associated with currently-viewed web page 46 are a plurality of linked content items, generally, 48. The linked content items 48 include a plurality of web pages 50-74 located within a plurality of different websites 76-82. Currently-viewed web page 46, and the web pages 50-60 each have one or more links 88. Each link 88 includes electronic instructions, such as an address, to access the currently-viewed web page 46 and/or other linked content items 48. The currently-viewed web page 46, within the website 76, was reached by following a link 88 on previously-viewed web page 50. Web page 50 was reached by following a link 88 on previously-viewed web page 52. Web pages 54-60 are each directly associated with a link 88 on the currently-viewed web page 46. Web pages 62-74 are indirectly associated with currently-viewed web page 46, by links 88 on pages 54-60.

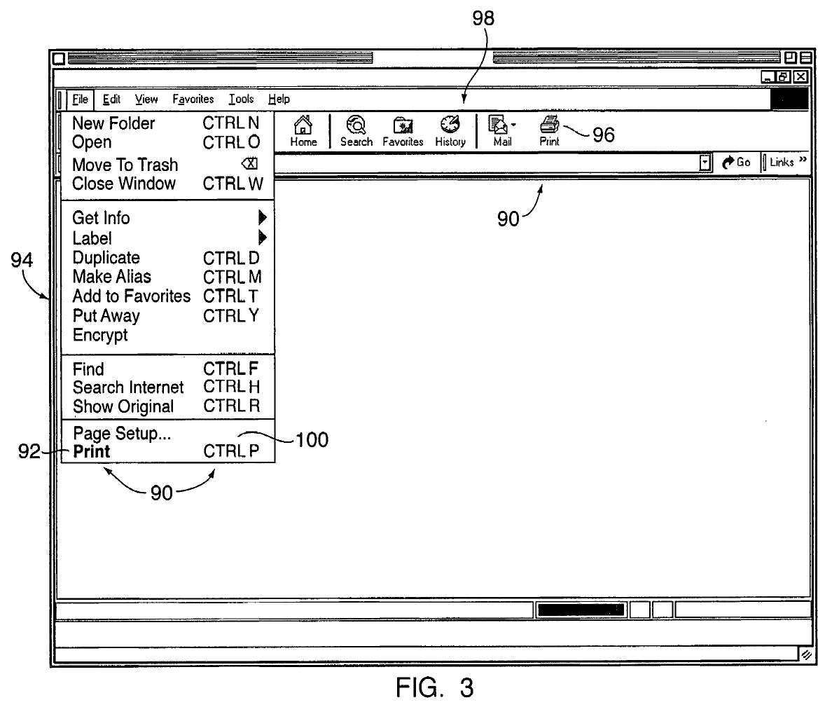

To select one or more linked content items 48 for printing, besides the currently-viewed web page 46, the print request 22 is generated by the request sub-module 14. Referring to FIG. 3, the request sub-module 14 is accessed by selecting a “Print” option 90, typically a “Print” menu option 92 in the “File” menu 94 of the application 13 (Internet browsing software, in the described embodiment), through a printer icon 96 on a tool bar 98 associated with the application 13, or through a macro-key combination, such as “CTRL-P” 100.

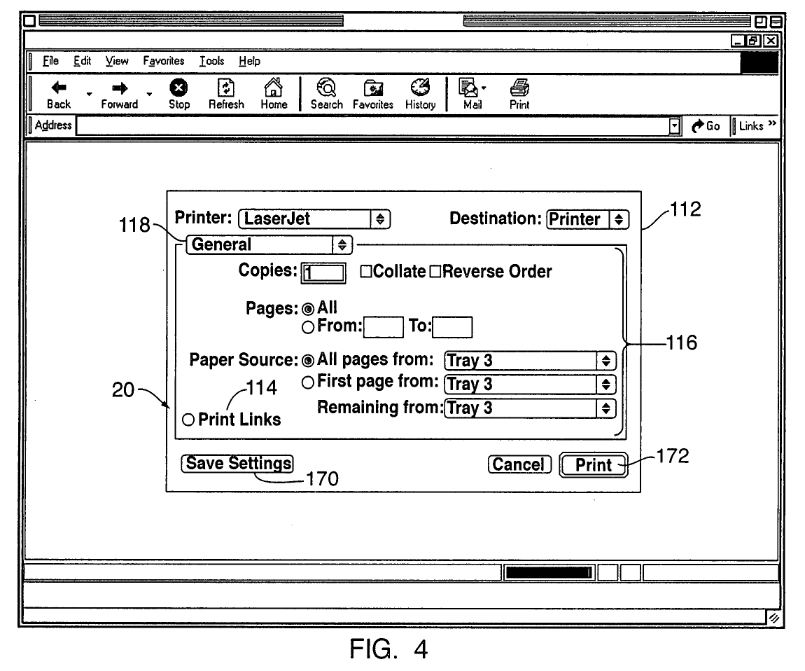

Referring to FIG. 4, selecting the “Print” option 90 results in the print request form 20 being displayed, typically in a print window 112. For smooth integration with existing print functionality, the print request form 20 initially appearing does not substantially differ in appearance from traditional print request forms (not shown), but includes a “Print links” option 114, in addition to a plurality of standard print request options 116. In selection box 118, “General” indicates that primarily the standard print request options 116 are being displayed in the print window 112.

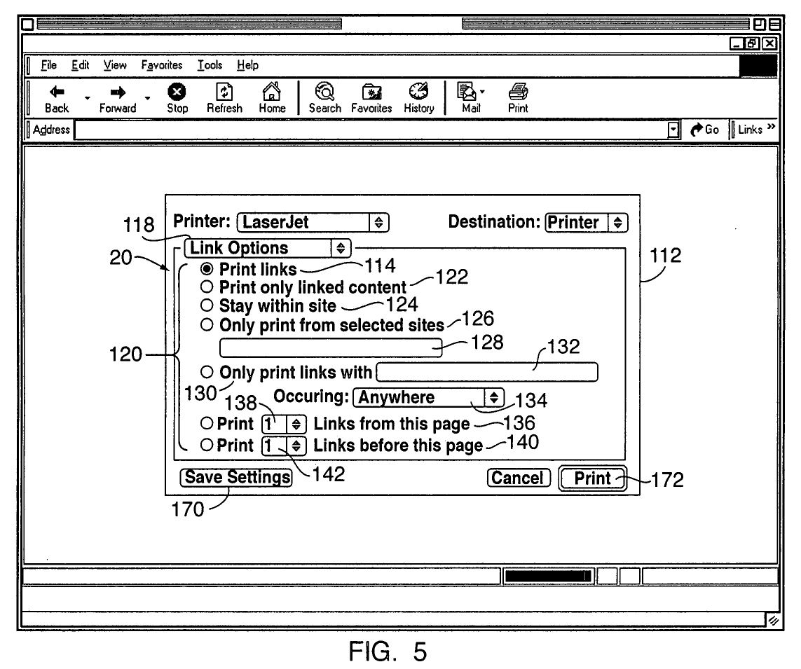

Referring to FIG. 5, upon selection of the “Print links” option 114, additional print request options 120 are displayed, preferably automatically, by the print request form 20, as indicated by “Link Options” appearing in the selection box 118. Display of the “Link Options” additional print request options 120 is also manually selectable using selection box 118. Exemplary additional print request options 120 are individually described, as follows.

By selecting a “Print only linked content” option 122, the currently-viewed web page 46 will not be printed, and only the linked content items 48 retrieved for printing, pursuant to the other print request options 120 selected, will be printed. If the option 122 is not selected, then both the currently-viewed web page 46, and the linked content items retrieved pursuant to the other print request options 120, will be printed. Linked content items are retrieved by the retrieval sub-module 18, the operation of which is described below.

By selecting a “Stay within site” option 124, linked content items 48 located on websites 78-82, as opposed to the website 76, on which the currently-viewed web page 46 is located, will not be retrieved. Alternately, selecting the “Only print from selected sites” option 126, allows the specification of one or more websites 76-82 from which linked content items are to be retrieved. For instance, if websites 76 and 80 are specified in data entry box 128, the linked content items 48 located on websites 78 and 82 will not be retrieved by the retrieval sub-module 18. Typically, one or more websites, such as websites 78 and 82, are specified in the data entry box 128 using respective root URLs, separated by a list separator, such as a comma or semicolon.

The print request form 20 also includes an “Only print links with” option 130, allowing only linked content items 48 including data (not shown) entered in data entry box 132 to be retrieved. The location within the linked content item 48, where the data entered in data entry box 132 must be located, is specified using selection box 134. Depending on the location specified in selection box 134, the data entered in data entry box 132 may, for instance, be located anywhere within a linked content item 48, or must be located within a particular location, such as a heading or title within the linked content item 48. For example, if only web pages 58 and 74 include the word “patent” (not shown) anywhere, and the option 130 is selected, the word “patent” is entered in data entry box 132, and “Anywhere” specified in selection box 134, then only web pages 58 and 74 will be retrieved by the retrieval sub-module 18, pursuant to the other print options 120.

The print request also includes a “Print ‘1’ Link(s) from this page” option 136, where ‘1’ is the depth to which links 88, relative to the current-viewed web page 46, are to be sequentially followed to obtain linked content items 48. Using selection box 138, ‘1’ is replaceable with a plurality of other numbers. For instance, if “Print ‘1’ Link(s) from this page” is selected, the selection would result in the retrieval of web pages 54-60, subject to other print request options 120. Web pages 62-74 would not be retrieved, as two links 88 would have to be sequentially followed to reach web pages 62-74 from the currently-viewed web page 46. If “Print ‘2’ Link(s) from this page” is selected, all the web pages 54-74 will be retrieved, subject to the other print request options 120.

The print request form 20 also includes a “Print ‘1’ Link(s) before this page” option 140, where ‘1,’ in the selection box 142, refers to the number of previous-viewed linked content items 48 to be retrieved for printing, typically based on the order in which any previously-viewed linked content items 48 were viewed. For instance, if “Print ‘2’ Link(s) before this page” is selected, both web pages 50 and 52 will be retrieved for printing, subject to the other print request options 120.

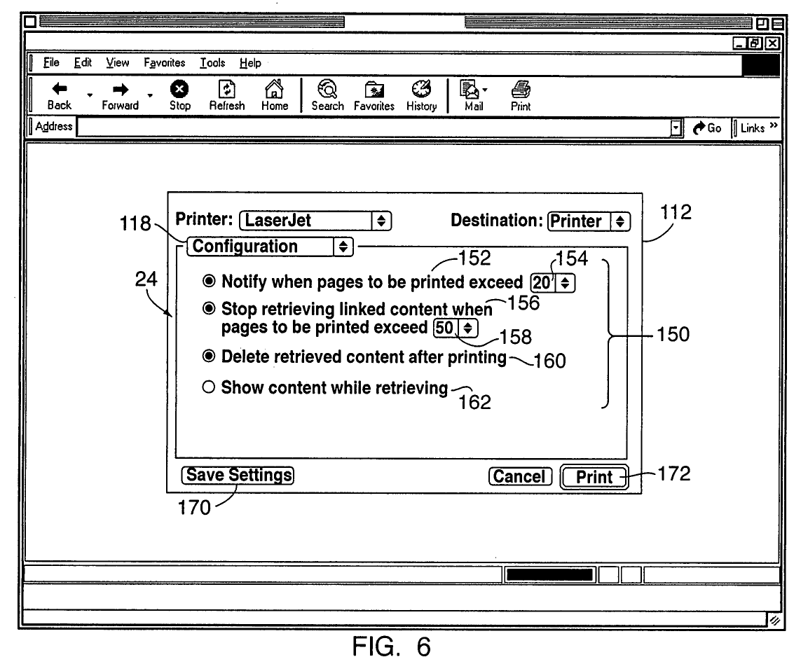

Referring to FIG. 6, selecting “Configuration” in the selection box 118, accesses the administration sub-module 16, which displays a configuration option form 24, used to generate the configuration data 26. A plurality of configuration options 150 are selectable using the configuration option form 24. Exemplary configuration options 150 are described, as follows.

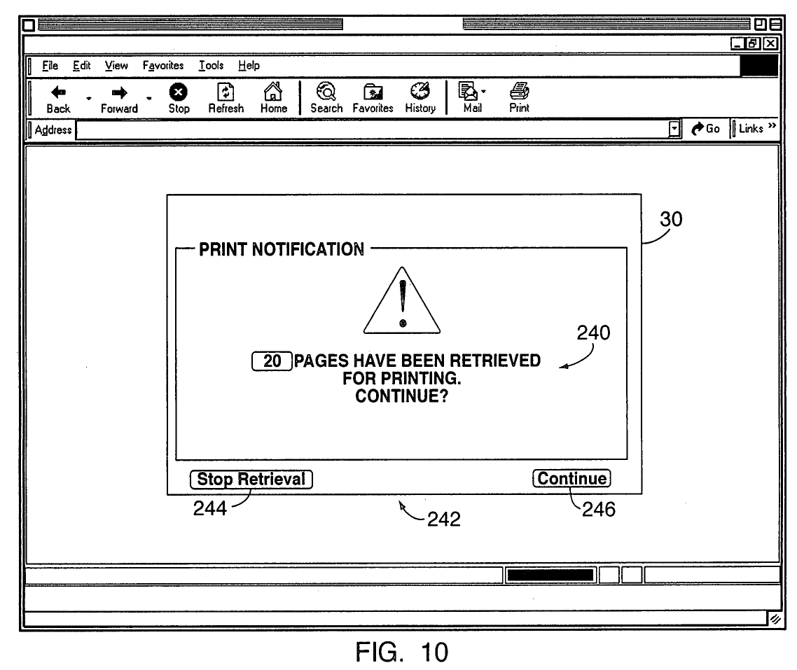

Selecting a “Notify when pages to be printed exceeds ‘20’” option 152, allows the retrieval sub-module to temporarily cease retrieving linked content items 48 when the number of pages already retrieved for printing equals the number specified in the selection box 154. When the number of pages specified in selection box 154 has been retrieved, a first notification 30 is displayed, as can be seen in FIG. 10. The number ‘20’ is replaceable with other quantities, depending on the desires or requirements of the user.

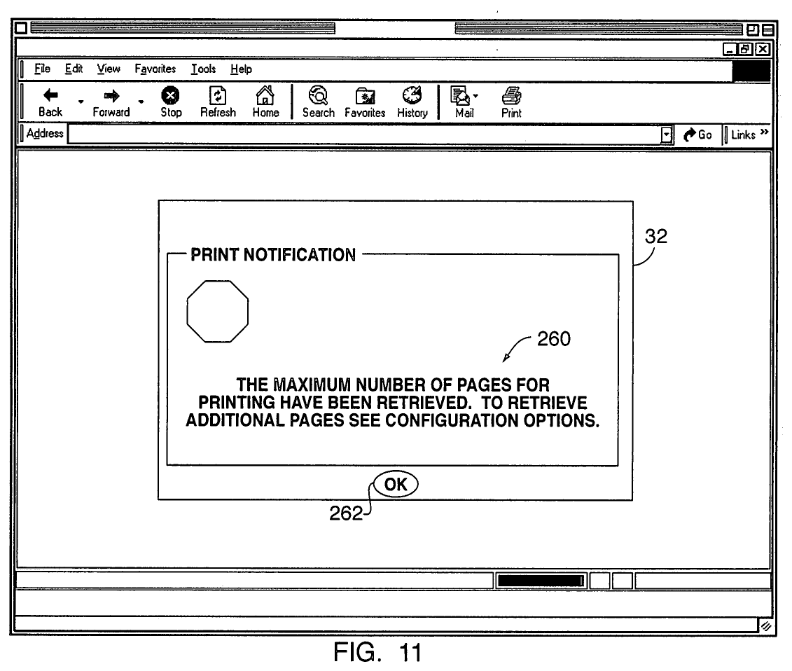

Selecting a “Stop retrieving linked content when pages to be printed exceeds ‘50’” option 156, results in the termination of the retrieval of linked content items 48, when the number of pages specified in selection box 158 is met or exceeded. A second notification 32 is also displayed, as can be seen in FIG. 11. Typically, while the number ‘50’ is replaceable with a plurality of other maximum number of pages to be printed, an upper limit is provided to the numbers available in selection box 158. For instance, selection box 158, can be limited to numbers from ‘1’ to ‘100.’

A “Delete retrieved content after printing” option 160, when selected, results in the automatic deletion of stored content items 28, which have been temporality stored for communication to a printer (not shown), after the stored content items 28 have been sent to the printer. To maximize available electronic storage capacity, for example, the option 160 is selected. If the stored content items 28 are, for example, desired or required for some other purpose after printing is completed, the option 160 is de-selected.

A “Show content while retrieving” option 162, allows the retrieval sub-module 18 to display linked content items 48, typically in another window (not shown), as the linked content items are being retrieved for printing. When the option 162 is de-selected, the linked content items 48 are retrieved without being displayed.

Once changes to the configuration options 150 in the configuration option form 24 are made, the configuration data 26 is generated, or re-generated, and stored for later availability to the retrieval sub-module 18 by selecting a “Save Settings” button 170 in the print window 112.

Once the print request form 20 and/or the configuration option form 24 have been modified and/or completed, to the extent required or desired by the user, a “Print” button 172 is selected. Selecting button 172 initiates the operation of retrieval sub-module 18 and communicates the print request 22 to the retrieval sub-module 18, the operation of which is described, below.

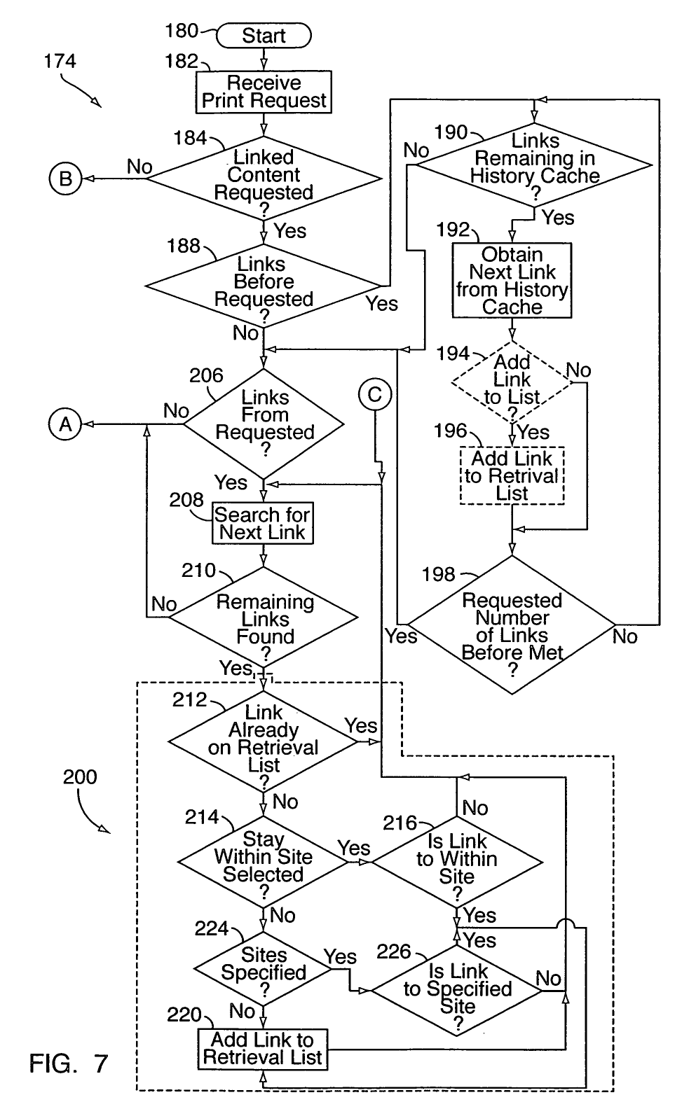

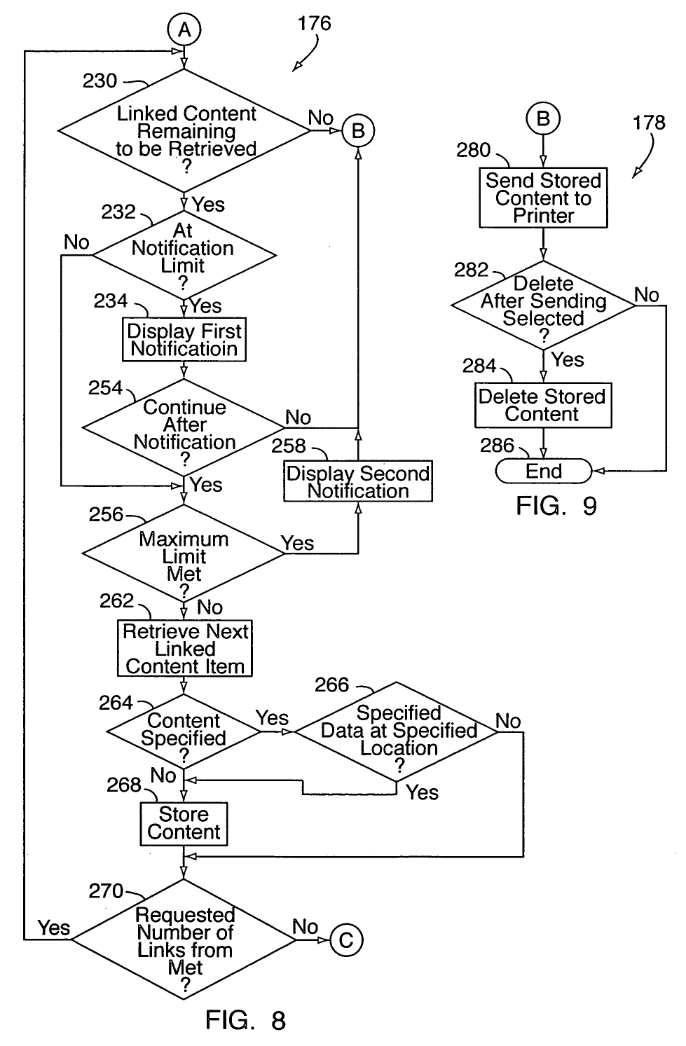

Referring to FIGS. 7-9, the retrieval sub-module 18, in operation, executes a compilation routine 174, a retrieval routine 176, and an output routine 178. The compilation routine 174 for compiling the retrieval list 34, begins once operation of the retrieval sub-module 18 is initiated (180) and the print request 22 is received (182) from the request sub-module 14. Any configuration data 26 that has been generated and saved using the administration sub-module 16 is also available to the retrieval sub-module 18. The retrieval sub-module 18 evaluates whether the print request 22 includes a request to print linked content items 48 (184), as would be indicated by the selection of the option 114 on the print request form 20. If a request to print linked content items 48 is not included (184), the retrieval sub-module immediately transitions to the output routine 178, as described below. If a request to print linked content items 48 is not included in the print request 22, typically the only content subject to the output routine 178 is the currently-viewed web page 46.

If the print request 22 does include a request to print linked content (184), the retrieval sub-module 18 evaluates whether the print request 22 includes a request to print links before (188) the currently-viewed web page 46, as would be indicated by the selection of the option 140 on the print request form 20. If the print request 22 includes a request to print links before (188) the currently-viewed web page 46, the retrieval sub-module 18 determines if a link to a previously-viewed web page remains in the history cache (190), and if so, obtains the link to the previously-viewed web page 50 from the history cache (192) and evaluates whether or not to add the link to the previously-viewed web page 50 to a retrieval list (194,196).

Whether or not previously-viewed web page 50 is added to the retrieval list (196), the retrieval sub-module evaluates whether the requested number of links before has been met (198), as would be indicated by the number in selection box 142. For instance, if ‘1’ was indicated in selection box 142, no further links would be obtained from the history cache (192) after obtaining the link to previously-viewed web page 50. If ‘2’ was indicated in selection box 142, the retrieval sub-module would obtain the link for previously-viewed web page 52 (192), if remaining in the history cache (190), and repeat steps 196 and 198 for previously-viewed we page 52.

The evaluation and action of steps 194 and 196, for links before the currently-viewed web page 46, is simplified for expediency, but is substantially similar to the process indicated generally at 200, for links from the currently-viewed web page 46, which process will be described below, in detail.

If the retrieval sub-module determines that links before were not requested (188), that no links remain in the history cache (190), or that the requested number of links before has been met (198), the retrieval sub-module then determines if the print request 22 includes a request to print links from (206) the currently-viewed web page 46, as would be indicated by the selection of option 136 on the print request form 20. If a request to print links from (206) the currently-viewed web page 46 is included in the print request 22, then the retrieval sub-module searches for the next link 88 (208) on the currently-viewed web page 46. If the retrieval sub-module determines that there are links 88 remaining (210), the retrieval sub-module then determines if the next link 88 is already on the retrieval list (212). For instance, if a link 88 to web page 68 had already been added to the retrieval list following the retrieval of web page 56, the link 88 would not be added to the retrieval list a second time following the retrieval of web page 60.

If the link 88 is not already on the retrieval list (212), the retrieval sub-module then determines if the print request 22 includes a request to stay within the website 76 (214) that includes the currently-viewed web page 46, as would be indicated by the selection of the option 124 on the print request form 20. If the print request 22 includes a request to stay within the website 76 (214), the retrieval sub-module then evaluates if the link 88 points to a linked content item 48 located within the website 76 (216). If the link 88 is to a linked content item 48 located within website 76 (216), the link 88 will be added to the retrieval list (220). For instance, links 88 on the currently-viewed web page 46 directed to web pages 54 and 56 satisfy the step 216 evaluation, as web pages 54 and 56 are both located within website 76.

If the print request 22 does not include a request to stay within the website 76 (214), the retrieval sub-module 18 determines if the print request 22 includes a request to only retrieve linked content items 48 from specified websites (224), as would be indicated by the selection of the option 126 on the print request form 20. If a request to only retrieve linked content items 48 from specified websites (224) is included in the print request 20, the retrieval sub-module then evaluates if the link 88 is directed to a linked content item 48 within a website specified (226) in the data entry box 128. If the link 88 is directed to a linked content item 48 within a specified website, the link 88 is added to the retrieval list (220). For instance, if websites 80 and 82 are specified within data entry box 128, links 88 on the currently-viewed web page 46 to web pages 58 and 60 satisfy the step 226 evaluation, as web pages 58 and 60 are located within websites 80 and 82, respectively.

Once the link 88 has been evaluated by the process 200 and either been added to the retrieval list (220) or not added, the retrieval sub-module 18 returns to step 208 and looks for another link 88 (208) on the currently-viewed web page 46. If there is a remaining link (210), the process 200 is repeated for the link. Once every link 88 on the currently-viewed web page 46 has been found and evaluated, or if the print request 20 does not include a request to print links from (206) the currently-viewed web page 46, the retrieval sub-module will transition to the retrieval routine 176, and determine if the linked content items 48 associated with any of the links 88 on the retrieval list are remaining to be retrieved (230).

If there are linked content items 48 remaining to be retrieved (230), the retrieval sub-module determines if the number of pages already retrieved for printing is at the notification limit (232) specified in selection box 154, if the configuration data 26 indicates the option 152 is selected. If the number of pages is at the limit specified in selection box 154, the first notification 30 is displayed (234). The first notification 30 is displayed only once, as the determination of step 232 is affirmative only if the number of pages already retrieved is at the notification limit, not if it is below or above the limit.

Referring to FIG. 10, the first notification 30 includes an information section 240 and a selection section 242. The selection section includes a “Stop retrieval” button 244 and a “Continue” button 246. In step 254, selecting the “Continue” button 246 results in the retrieval routine 176 continuing, whereas selecting the “Stop retrieval” button 244 will result in a transition from the retrieval routine 176 to an output routine 178, as described below.

Referring again to FIGS. 7-9, if the number of pages retrieved is not at the notification limit (232), or if it determined to continue after the first notification 30 is displayed (254), the retrieval sub-module 18 will further determine whether a maximum limit on the number of pages to be retrieved has been met (256), based on the number in selection box 158, if the option 156 is selected. If the number of pages specified in selection box 158 has already been retrieved, then the maximum limit has been met and the second notification 32 is displayed (258).

Referring to FIG. 11, the second notification 32 has an information section 260 and an “OK” button 262 allowing for user acknowledgment of the second notification. Referring again to FIGS. 7-9, once the second notification 32 is displayed (258), there is no option to continue retrieval and the retrieval sub-module transitions to the output routine 178.

If the maximum limit has not been met (256), the next linked content item 48 is retrieved (262). The retrieval sub-module 18 evaluates if the print request 22 includes a request to only print linked content items 48 having specified data (264), as would be indicated by selection of the option 130 on the print request form 20. If a request to only print linked content items 48 having specified data is present (264), the retrieval sub-module evaluates if the specified data, as entered in data entry box 132, is present and in the specified location (266), based on the selection in selection box 134. If the print request 22 does not include a request to print only linked content items 48 having specified data (264) or if the specified data is present in the specified location (266), the retrieval sub-module 18 then stores the linked content item 48 (268). Typically, stored content items 28 are stored in a temporary directory, until sent for printing, as will be discussed below.

If printing only linked content items 48 with specified data has been requested (264), but the specified data is not present in the specified location (266), the linked content item 48 is not stored in the temporary directory. Whether or not the linked content item is stored (268), the retrieval sub-module determines if the requested number of links from has been met (270), as indicated by the number specified in selection box 138.

For instance, if ‘2’ is specified and web page 56 is the linked content item 48 currently retrieved and evaluated by the retrieval routine, then the step 270 evaluation will not be satisfied as web page 56 is only one link from the currently-viewed web page 46. If the step 270 evaluation is not satisfied, the retrieval sub-module 18 transitions back to the compilation routine 174. Web page 56 is searched for links 88 (208), similarly to the currently-viewed web page 46. Any links 88 that are found (210) are evaluated by process 200, as described above, and added to the retrieval list 34, as appropriate.

If there are no more links 88 to be found (210) on the linked content item 48 being searched, web page 56 in the preceding example, or if the step 270 evaluation was satisfied, the retrieval routine 176 continues, again evaluating if linked content items are remaining to be retrieved (230), and repeating the steps 232-270, as applicable.

Once there are no linked content items remaining to be retrieved (230), based on no links remaining on the retrieval list 34 that have not yet been retrieved, or the stop retrieval button 244 has been selected after receiving the first notification 30 (234, 254), or the maximum limit has been met (256) and the second notification displayed (258), or the print request 22 did not include a request to print linked content items (184), the retrieval sub-module 18 transitions to the output routine 178.

Preferably using the print functionality of the existing electronic application 13 and installed print drivers (not shown), the stored content items 28 are sent to the printer (280) for printing. The retrieval sub-module 18 determines whether the configuration data includes instructions to delete the stored content items 28 after the stored content items 28 are sent to the printer (282), as indicated by the selection of option 160 on the configuration option form 24. If the stored content items 28 are to be deleted (282), the retrieval sub-module 18 deletes the stored content items (284), and the operation of the retrieval sub-module 18 is complete (286) until another print request 22 is received.

It will be understood by those skilled in the art, that the present invention is not limited to the embodiments herein described, and that other variations and modifications, and adaptations to different circumstances, may be made within the scope of the present invention.

Although, in the embodiment described, the printing tool is a plug-in module for an existing electronic application, the printing tool is also adaptable for use as an independent module, not needing to be “plugged-in” to an existing application.

The present invention is not limited to use in connection with Internet browser software, but can be used in connection with any electronic application for viewing electronic content that includes links to linked content items. The present invention can be used in connection with multiple applications, for instance where a link in electronic content viewed using one electronic application is associated with linked content viewable only using a different electronic application. The modules and sub-modules can be combined or further separated while still operating and additional inputs and outputs are advantageously employable.

The electronic environment 40 is used as a context for describing the functions and operations of the above embodiment and does not limit the scope or application of the present invention. For example, the present invention is equally applicable to more numerous linked content items 48 and more numerous and greater numbers and levels of links 88, as well as to other types of linked content items than the web pages 50-74.

Additional methods of accessing the request sub-module can advantageously be employed. The print request options 120 need not be included within the print request form 20. For example, a separate “File” menu option, tool bar icon, or macro can be used for each or all of the various options. Other print request options 120 can also be included in the print request form without departing from the scope of the present invention. Other arrangements of print request options 120 within the print window can be used.

Both print request options 120 and configuration options 150 can be added or removed. Options included in the administration sub-module 16 can alternately be included in the request sub-module 14 and vice versa. Password protection can prevent unauthorized alteration of one ore more options 120 and/or 150.

Examples of other options 120 or 150 can include restricting the linked content items to be retrieved by categories such as text only, pictures only, no adult content, and the like. An option can be given to print only selected links. Additionally, a print request can request only selected portions of a linked content item be printed, rather than the entire linked content item.

Instead of, or in addition to, using the history cache to find links to previously-viewed linked content items, the hierarchical structure of a website or other file system may be used to find linked content items on a pre-determined number of levels “above” the currently-viewed content. Links to other content on previously-viewed linked content items can be followed to gather additional linked content items.

Although, in the context of Internet browsing software, the retrieval sub-module 18 typically retrieves linked content items by accessing the links 88 over the Internet, linked content items are also retrievable in other manners. For instance, linked content items 48 may be retrieved using some other network, such as a local area network, or linked content items 48 may be retrieved that are locally stored. Linked content items that are locally stored can include web pages temporality stored for some other purpose, such as faster subsequent accessing of the web pages. Whether the retrieval sub-module 18 accesses locally stored web pages can be included in the configuration data and selected using an additional option within the administration sub-module.

In the context of some other type of application, such a word processing application, a link in a word processing document may also point to another word processing document, or to some other type of file, that is stored locally. In such an instance, the link may not point to a URL, but to a file location using a local file address provided by a local file management system. The retrieval sub-module 18 is then able to retrieve the other document or file using this file address.

In the course of retrieving linked content items 48, the electronic format of a given linked content item (not shown) may be different from the electronic formats accessible by the application 13. In these instances, the retrieval sub-module is able to launch the appropriate application, typically in the background, and access the given linked content item using the appropriate application.

The steps described in connection with the operation of the retrieval sub-module 18, above, may be performed in any logical order, as will be clear to those skilled in the art. Additionally, steps may be added or omitted, depending on circumstances and the needs and/or desires of a given user of the printing tool 10.

The printing tool works in connection with other printing operations, in addition to printing on a printer, such as print preview, print to file, save as PDF, Fax, and the like. Accordingly, the terms “print,” “printed,” and “printing,” as used herein, do not exclusively refer to the physical printing of the linked content items by a printer, but encompass all printing operations, unless otherwise specified. The printing tool may also have its own printing sub-module for communicating content to be printed to the printer. The option of delaying retrieval and/or printing until a log-out or a pre-determined time can be given.

Instead of automatically printing upon completion of the retrieval routine 176, a summary of linked content items to be printed may be displayed and approval requested, and further limitation or restriction of the linked content items requested to be printed may be allowed when the summary of content is displayed.

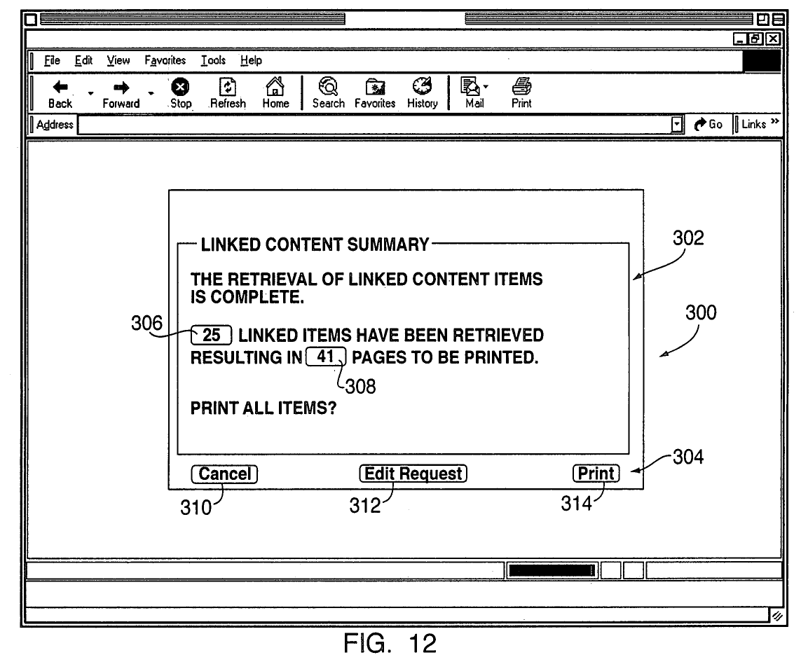

Referring to FIG. 12, a linked content summary 300 includes an information section 302 and a selection section 304. The information section 302 indicates, among other things, a number of linked content items retrieved 306 and the a number of pages to be printed 308 resulting from the number of linked content items retrieved 306. The selection section 304, includes a “Cancel” button 310, for canceling the print request and printing none of the stored content items 28, an “Edit request” button 312 for further limitation or restriction of the linked content items requested to be printed, and a “Print” button, for approving the summary and continuing with a printing operation.

In addition to the numbers of pages in selection boxes 154 and 158, limitations on the retrieval routine can be expressed as a data quantity, such a bytes of storage used, or a total number of linked content items regardless of the number of pages required to print the linked content items.

These and other modifications and variations are all possible within the scope of the present invention.

I claim:

1. A printing tool comprising:
a module allowing printing of at least one linked content item.

2. The printing tool of claim 1, wherein the module further allows a selection of the at least one linked content item to be printed.

3. The printing tool of claim 2, wherein the selection includes a specification of a number of links, from or before a currently-viewed content item, to the at least one linked content item.

4. The printing tool of claim 2, wherein the selection includes a specification of data that must be present in the at least one linked content item.

5. The printing tool of claim 4, wherein the selection further includes a specification of a location where the data must be present in the at least one linked content item.

6. The printing tool of claim 2, wherein the selection includes a specification of a website in which the at least one linked content item must be located.

7. The printing tool of claim 1, wherein the module further allows displaying of a linked content summary before printing.

8. The printing tool of claim 7, wherein the module further allows selection of the at least one linked content item to be printed, after the linked content summary is displayed.

9. The printing tool of claim 1, wherein the module allows a plurality of linked content items to be printed and further allows a limit to be selected for the plurality of linked content items to be printed.

10. The printing tool of claim 9, wherein the module further allows a notification to be displayed when the limit is reached.

11. A printing tool comprising:
a request sub-module for generating a request to print at least one linked content item.

12. The printing tool of claim 11, wherein the request sub-module generates the request based on a print request form.

13. The printing tool of claim 12, wherein the print request form includes a plurality of options for specifying the at least one linked content item to be included in the request.

14. The printing tool of claim 13, wherein one of the plurality of options includes an option to print only the at least one linked content item.

15. The printing tool of claim 13, wherein one of the plurality of options includes an option to stay within a current website.

16. A printing tool comprising:
a retrieval sub-module allowing at least one linked content item to be retrieved for printing.

17. The printing tool of claim 16, wherein the retrieval sub-module compiles a retrieval list including at least one link to the at least one linked content item.

18. The printing tool of claim 17, wherein the retrieval sub-module is prevented from adding duplicative links to the retrieval list.

19. The printing tool of claim 17, wherein the retrieval sub-module obtains the at least one link from a history cache.

20. The printing tool of claim 17, wherein the retrieval sub-module obtains the at least one link by searching for the at least one link within a content item.
